(19) United States
(12) Patent Application Publication
(10) Pub. No.: US 2014/0054151 A1
(43) Pub. Date: Feb. 27, 2014

(54) TOUCH PANEL AND TOUCH DISPLAY APPARATUS USING SAME

(71) Applicant: TIANJIN FUNAYUANCHUANG TECHNOLOGY CO.,LTD., Tianjin (CN)

(72) Inventor: HO-CHIEN WU, New Taipei (TW)

(73) Assignee: TIANJIN FUNAYUANCHUANG TECHNOLOGY CO.,LTD., Tianjin (CN)

(21) Appl. No.: 13/972,952

(22) Filed: Aug. 22, 2013

(30) Foreign Application Priority Data
Aug. 24, 2012 (CN) 2012103046703

(51) Int. Cl. H01H 13/807

(52) U.S. Cl. CPC H01H 13/807; Y10S 977/956; B82Y 15/00
USPC 200/5 A; 977/956

(57) ABSTRACT

A touch panel includes a first sub-panel and a second sub-panel. One of the first sub-panel and the second sub-panel comprises a carbon nanotube (CNT) film. Each of the first sub-panel and the second sub-panel comprises a touch sensing region and a first side region connecting a first side of the touch sensing region. The first side region is bent towards the touch sensing region and an intersection angle is formed between the side region and the touch sensing region. The first side region of the first sub-panel is attached to the first side region of the second sub-panel such that the touch sensing region of the first sub-panel and the touch sensing region of the second sub-panel are joined together.

### CROSS-REFERENCE TO RELATED APPLICATIONS

This application claims all benefits accruing under 35 U.S.C. §119 from China Patent Application No. 201210304670.3, filed on Aug. 24, 2012 in the China Intellectual Property Office, the content of which is hereby incorporated by reference in its entirety. This application is related to commonly-assigned applications entitled, “CARBON NANOTUBE TOUCH PANEL AND TOUCH DISPLAY APPARATUS USING SAME” filed **** (Atty. Docket No. US46684), “CARBON NANOTUBE TOUCH PANEL HAVING TWO CARBON NANOTUBE FILMS” filed **** (Atty. Docket No. US46691), “CARBON NANOTUBE TOUCH PANEL HAVING AT LEAST TWO CARBON NANOTUBE FILMS” filed **** (Atty. Docket No. US46692), “CARBON NANOTUBE TOUCH PANEL AND METHOD FOR MAKING SAME” filed **** (Atty. Docket No. US46693), “CARBON NANOTUBE TOUCH PANEL AND TOUCH DISPLAY APPARATUS USING SAME” filed **** (Atty. Docket No. US46694), and “TOUCH PANEL AND TOUCH DISPLAY APPARATUS USING SAME” filed **** (Atty. Docket No. US46960).

### BACKGROUND

1. Technical Field

The present disclosure relates to touch sensing technologies, and more particularly, to a touch panel with at least one carbon nanotube (CNT) film and a touch display apparatus using the touch panel.

2. Description of Related Art

Touch display apparatuses normally include a display assembly and a touch panel attached to the display assembly. Carbon nanotube (CNT) touch panels are widely used because of the durability of CNT touch panels. A CNT touch panel includes a plurality of carbon nanotubes arranged in parallel on a substrate. However, conductivity of the carbon nanotubes decrease as a length of the CNT unit increases. This characteristic is a limit in design, and making a CNT touch panel with a large size is problematic.

What is needed is to provide a means that can overcome the above-described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic view of a touch panel according to a first embodiment of the present disclosure.

FIG. 2 is an exploded view of the touch panel of FIG. 1.

FIG. 3 is a detailed plan view of the touch panel of FIG. 2.

FIG. 4 is a schematic view of a CNT film of the touch panel of FIG. 1.

FIG. 5 is a detailed plan view of the touch panel of FIG. 1.

FIG. 6 is a schematic view of a touch panel according to a second embodiment of the present disclosure.

FIG. 7 is an exploded and detailed plan view of the touch panel of FIG. 6.

FIG. 8 is a detailed plan view of the touch panel of FIG. 6.

FIG. 9 is an exploded view of a touch panel according to a third embodiment of the present disclosure.

FIG. 10 is a schematic view of the touch panel of FIG. 9.

FIG. 11 is a schematic view of a touch display apparatus according to an embodiment of the present disclosure.

### DETAILED DESCRIPTION

Reference will be made to the drawings to describe various embodiments.

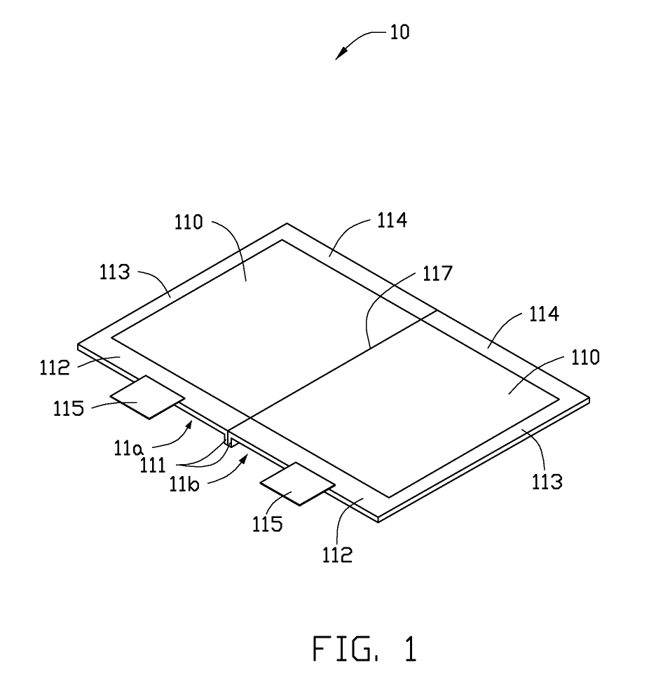

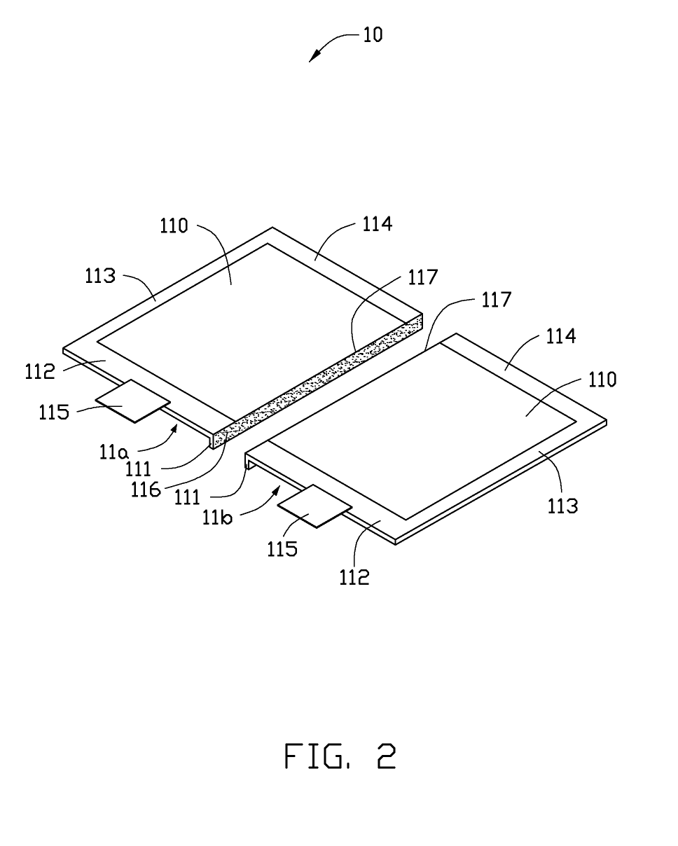

FIGS. 1-2 show that a touch display apparatus 10 according to a first embodiment of the present disclosure. The touch display apparatus 10 includes a first sub-panel 11a and a second sub-panel 11b. In the embodiment, both of the first sub-panel 11a and the second sub-panel 11b are CNT touch panels and include a CNT film.

Each of the first sub-panel 11a and the second sub-panel 11b includes a touch sensing region 110, a first side region 111, a second side region 112, a third side region 113, a fourth side region 114 and a flexible printed circuit (FPC) 115. The touch sensing region 110 is located in a main central region of the CNT sub-panel 11a or 11b. The first side region 111, the second side region 112, a third side region 113, and the fourth side region 114 are connected four sides of the touch sensing region 110 respectively, and The first side region 111, the second side region 112, a third side region 113, and the fourth side region 114 are arranged end to end to form a periphery region surrounding the touch sensing region 110. The FPC 115 is mounted on and electrically connected to an edge of the second side region 112. The first side region 111 and the third side region 113 are located adjacent to opposite ends of the touch sensing region 110. The second side region 112 and the fourth side region 114 are located adjacent to the other two opposite ends of the touch sensing region 110.

The first side region 111 is bent towards the touch sensing region 110 and an intersection angle is formed between the first side region 111 and the touch sensing region 110. In the embodiment, the intersection angle is 90 degrees, that is, the first side region 111 is perpendicular to the touch sensing region 110. The first side region 111 of the first sub-panel 11a is adjacent to the first side region 111 of the second sub-panel 11b and is attached to the first side region 111 of the second sub-panel 11b by an adhesive layer 116, such that the touch sensing region 110 of the first sub-panel 11a and the touch sensing region 110 of the second sub-panel 11b are joined. Furthermore, the second side region 112 of the first sub-panel 11a and the second side region 112 of the second sub-panel 11b are joined, and the fourth side region 114 of the first sub-panel 11a and the fourth side region 114 of the second sub-panel 11b are joined.

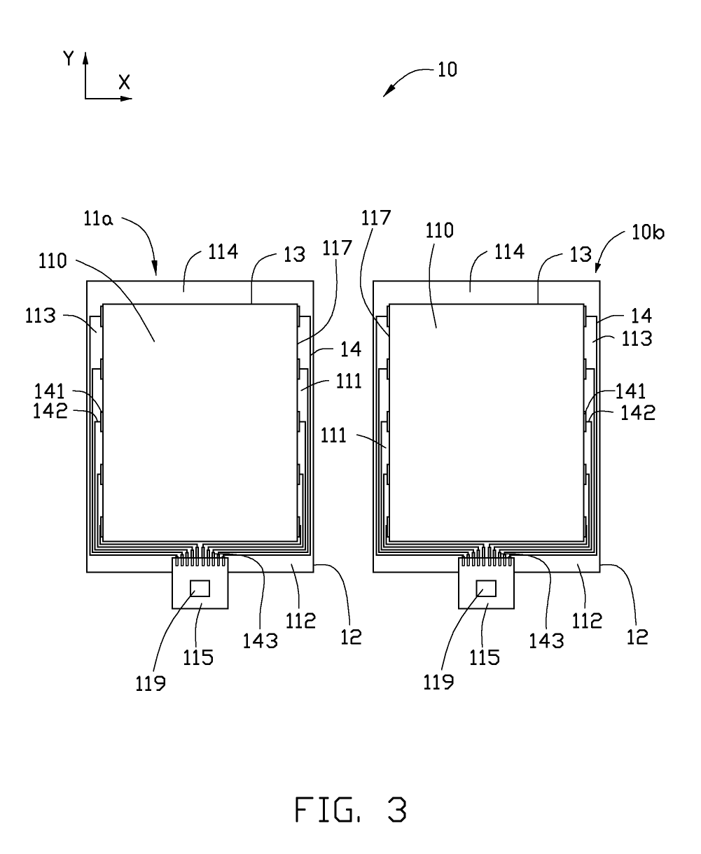

FIG. 3 shows that a detailed plan view of the touch panel 10 before the first side region 111 of the first sub-panel 11a is attached to the first side region 111 of the second sub-panel 11b. It can be seen that, in the FIG. 3, the first side region 111 and the touch sensing region 110 are in the same plane. The first CNT sub-panel 11a has a configuration substantially the same as the second CNT sub-panel 11b, but differs in that a location of the first side region 111 and the third side region 113 in the first sub-panel 11a is opposite to a location of the first side region 111 and the third side region 113 in the second sub-panel 11b. For example, in the first sub-panel 11a, the first side region 111 is located in a right side of the touch sensing region 110, and the third side region 113 is located in a left side of the touch sensing region 110. In the second sub-panel 11b, the first side region 111 is located in a left side of the touch sensing region 110, and the third side region 113 is located in a right side of the touch sensing region 110.

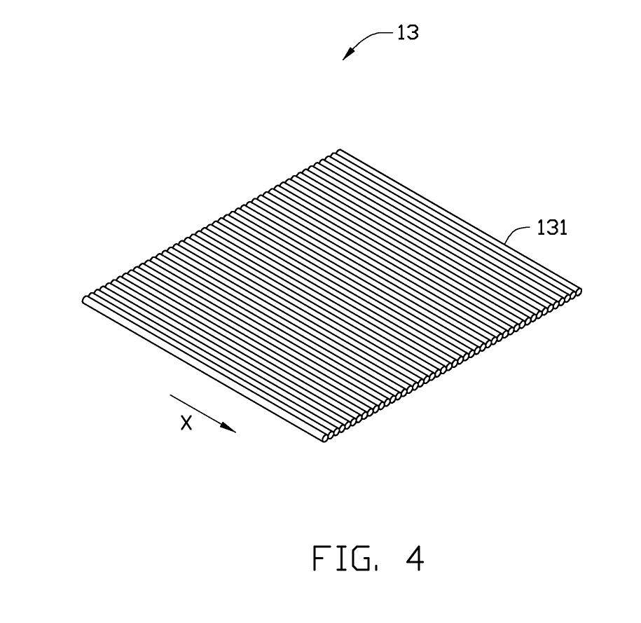

Each of the first sub-panel 11a and the second sub-panel 11b further includes a base 12 and a plurality of connection wires 14. The CNT film 13 is positioned on the base 12 and covers the touch sensing region 110. Referring to FIG. 4, the CNT film 13 includes a plurality of carbon nanotubes 131 orderly arranged, and the plurality of carbon nanotubes 131 are arranged along a first direction X. The touch sensing region 110 includes a first side line 117 adjacent to the first side region 111, and the first side line 117 is parallel to a second direction Y perpendicular to the first direction X.

The plurality of connection wires 14 are positioned on the periphery region surrounding the touch sensing region 110 and are electrically coupled between the CNT film 13 and the FPC 115. Each connection wire 14 includes a first electrode 141 electrically connected to the CNT film 13, a second electrode 143 electrically connected to the FPC 115, and a first connection portion 142 connected between the first electrode 141 and the second electrode 143. In the embodiment, the first electrodes 141 are positioned on the first side region 111 and the third side region 113, and the second electrodes 142 are positioned on the second side region 112. Moreover, the first electrodes 141 positioned on the first side region 111 are arranged along the second direction Y, the first electrodes 141 positioned on the third side region 113 are arranged along the second direction Y, and the second electrodes 142 positioned on the second side region 112 are arranged along the first direction X.

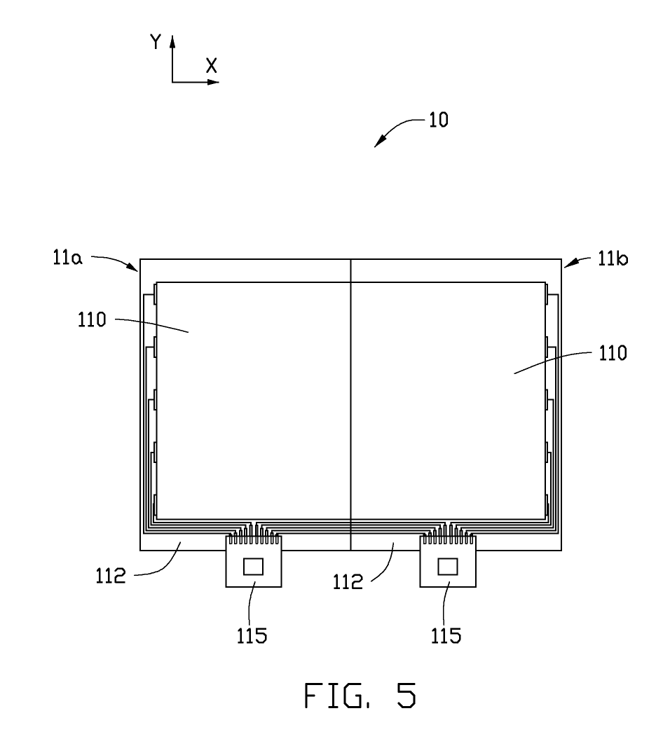

FIG. 5 shows that a detailed plan view of the touch panel 10 after the first side region 111 of the first sub-panel 11a is attached to the first side region 111 of the second sub-panel 11b. It can be seen that, the touch sensing region 110 of the first sub-panel 11a and the touch sensing region 110 of the second sub-panel 11b are joined to form a large touch sensing region of the touch panel 10. The second side region 112 of the first sub-panel 11a and the second side region 112 of the second sub-panel 11b are joined, and the two FPCs 115 extend out from the same side of the touch panel 10.

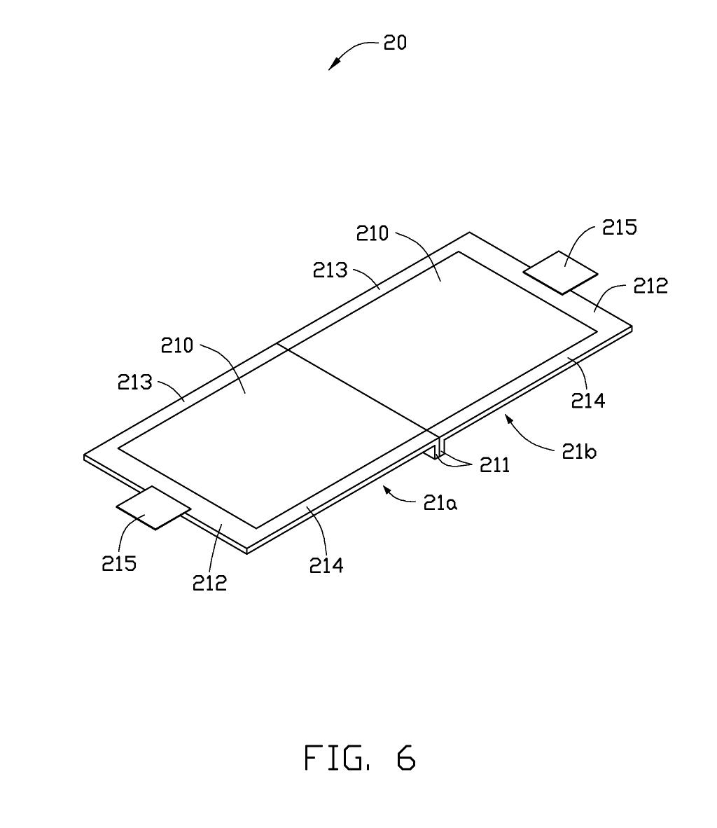

FIG. 6 shows that a schematic view of a touch panel 20 according to a second embodiment of the present disclosure. The touch panel 20 includes a first sub-panel 21a and a second sub-panel 21b. In the embodiment, both of the first sub-panel 21a and the second sub-panel 21b are CNT touch panels and include a CNT film.

Each of the first sub-panel 21a and the second sub-panel 21b includes a touch sensing region 110, a first side region 211, a second side region 212, a third side region 213, a fourth side region 214 and a flexible printed circuit (FPC) 215. The touch sensing region 210 is located in a main central region of the CNT sub-panel 21a or 21b. The first side region 211, the second side region 212, a third side region 213, and the fourth side region 214 are connected four sides of the touch sensing region 210 respectively, and The first side region 211, the second side region 212, a third side region 113, and the fourth side region 214 are arranged end to end to form a periphery region surrounding the touch sensing region 210. The FPC 215 is mounted on and electrically connected to an edge of the second side region 212. The first side region 211 and the second side region 212 are located adjacent to opposite ends of the touch sensing region 210. The third side region 213 and the fourth side region 214 are located adjacent to the other two opposite ends of the touch sensing region 210.

The first side region 211 is bent towards the touch sensing region 210 and an intersection angle is formed between the first side region 211 and the touch sensing region 210. In the embodiment, the intersection angle is 90 degrees, that is, the first side region 211 is perpendicular to the touch sensing region 210. The first side region 211 of the first sub-panel 21a is adjacent to the first side region 211 of the second sub-panel 21b and is adhered to the first side region 211 of the second sub-panel 21b, such that the touch sensing region 210 of the first sub-panel 21a and the touch sensing region 210 of the second sub-panel 21b are joined. Furthermore, the third side region 213 of the first sub-panel 21a and the third side region 213 of the second sub-panel 21b are joined, and the fourth side region 214 of the first sub-panel 21a and the fourth side region 214 of the second sub-panel 21b are joined.

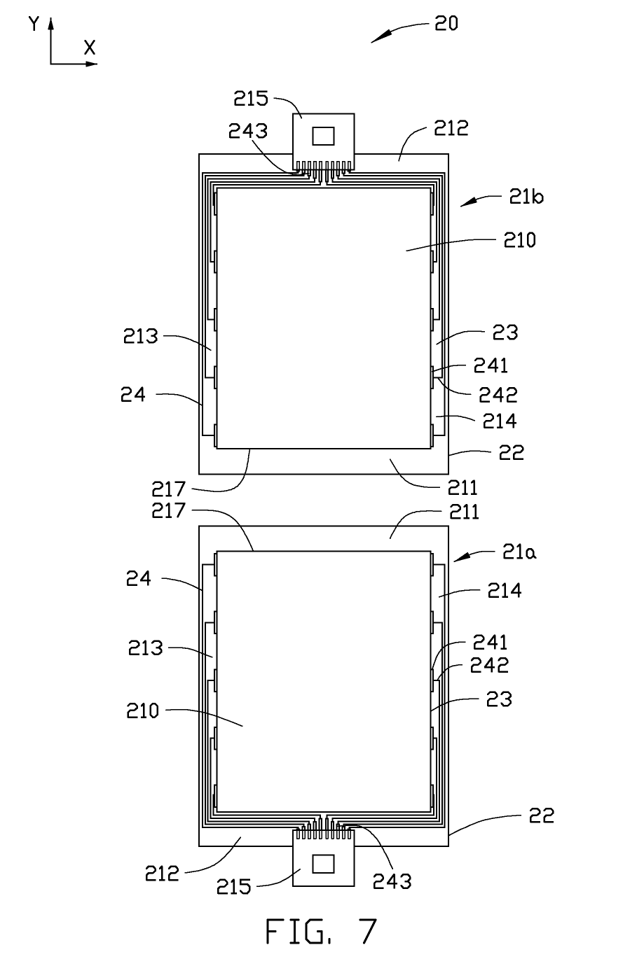

FIG. 7 shows that a detailed plan view of the touch panel 20 before the first side region 211 of the first sub-panel 21a is attached to the first side region 211 of the second sub-panel 21b. It can be seen that, in the FIG. 7, the first side region 211 and the touch sensing region 210 are in the same plane. The first CNT sub-panel 21a has a configuration substantially the same as the second CNT sub-panel 21b, but differs in that a location of the first side region 211 and the second side region 213 in the first sub-panel 21a is opposite to a location of the first side region 211 and the second side region 212 in the second sub-panel 21b. For example, in the first sub-panel 21a, the first side region 211 is located in an upper side of the touch sensing region 210, and the second side region 212 is located in a lower side of the touch sensing region 210. In the second sub-panel 21b, the first side region 211 is located in a lower side of the touch sensing region 210, and the second side region 212 is located in an upper side of the touch sensing region 210.

Each of the first sub-panel 21a and the second sub-panel 21b further includes a base 22 and a plurality of connection wires 24. The CNT film 23 is positioned on the base 22 and covers the touch sensing region 210. Referring to FIG. 4, The CNT film 23 may also include a plurality of carbon nanotubes orderly arranged, and the plurality of carbon nanotubes are arranged along the first direction X. The touch sensing region 210 includes a first side line 217 adjacent to the first side region 211, and the first side line 217 is parallel to the first direction X.

The plurality of connection wires 24 are positioned on the periphery region surrounding the touch sensing region 210 and are electrically coupled between the CNT film 23 and the FPC 215. Each connection wire 24 includes a first electrode 241 electrically connected to the CNT film 23, a second electrode 243 electrically connected to the FPC 215, and a first connection portion 242 connected between the first electrode 241 and the second electrode 243. In the second embodiment, the first electrodes 241 are positioned on the third side region 213 and the fourth side region 214, and the second electrodes 242 are positioned on the second side region 212. Moreover, the first electrodes 241 positioned on the third side region 213 are arranged along the second direction Y, the first electrodes 141 positioned on the fourth side region 214 are arranged along the second direction Y, and the second electrodes 242 positioned on the second side region 212 are arranged along the first direction X.

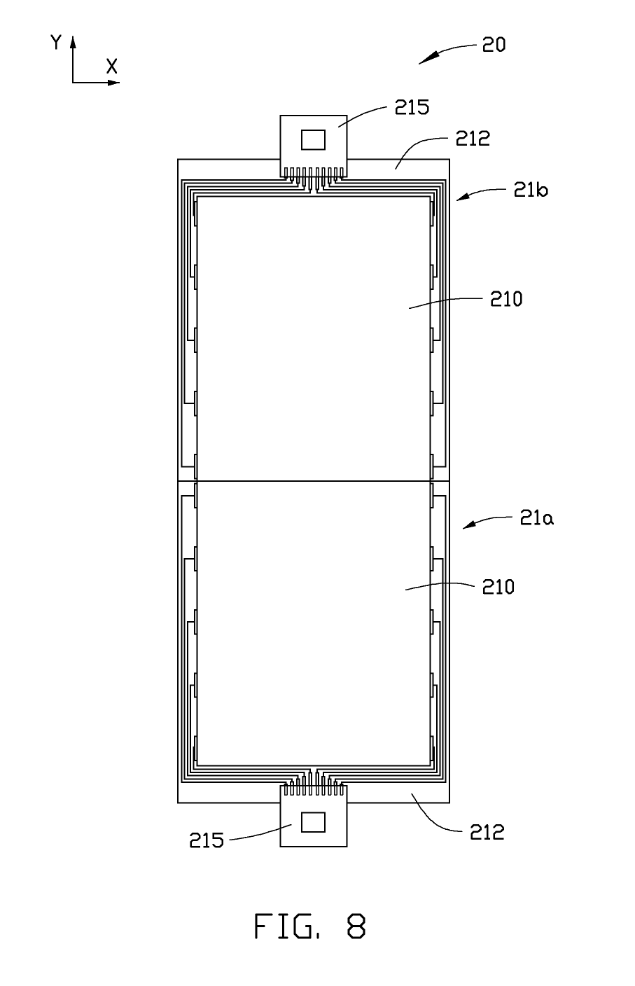

FIG. 8 shows that a detailed plan view of the touch panel 20 after the first side region 211 of the first sub-panel 21a is attached to the first side region 211 of the second sub-panel 21b. It can be seen that, the touch sensing region 210 of the first sub-panel 21a and the touch sensing region 210 of the second sub-panel 11b are joined to form a larger touch panel. The second side region 212 of the first sub-panel 21a and the second side region 212 of the second sub-panel 21b are positioned at two opposite sides of the touch panel 20, and the two FPCs 215 extend out from the two opposite sides of the touch panel 20.

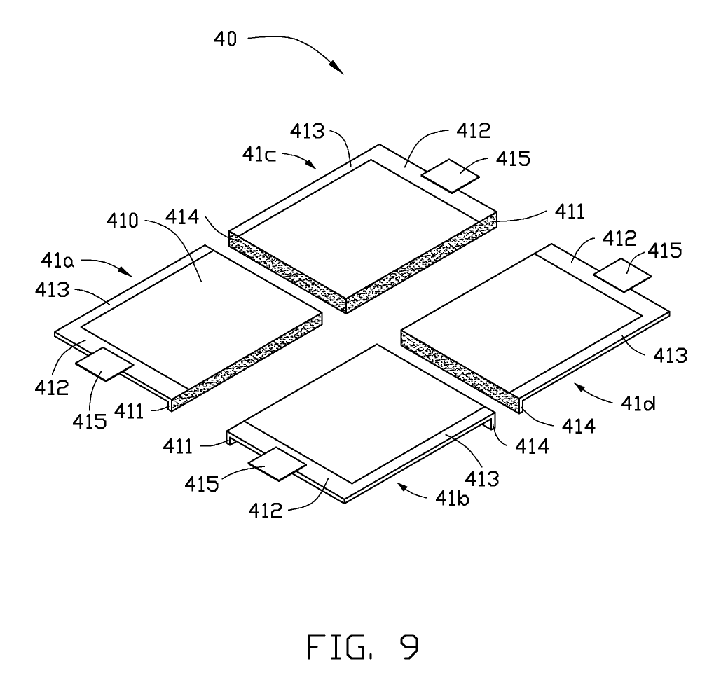

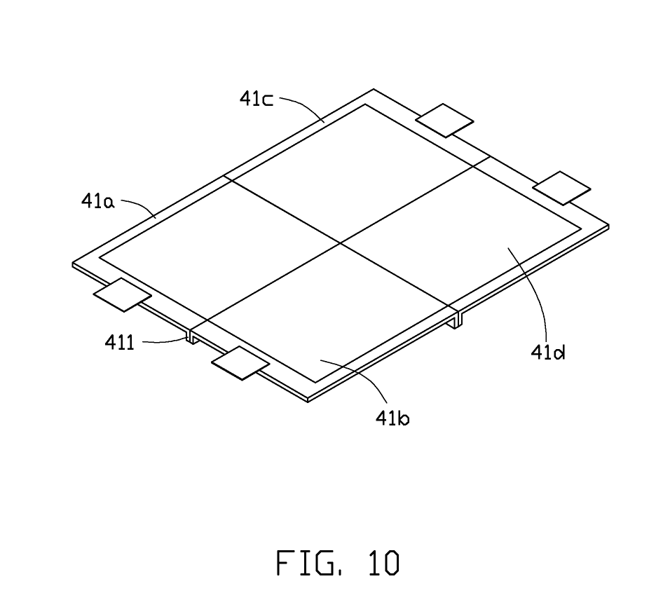

Referring to FIG. 9 and FIG. 10, a touch panel 40 according to a third embodiment of the present disclosure is similar to the above-described touch panel 10 according to the first embodiment, but differs in the following aspects: the touch panel 40 further includes a third sub-panel 41c and a fourth sub-panel 41d. In detail, each of the third sub-panel 41c and the fourth sub-panel 41d comprises a touch sensing region 410, a first side region 411, a second side region 412 adjacent to the first side region 411, a third side region 413 opposite to the first side region 411, a fourth side region 414 opposite to the second side region 412, and a FPC 415 connected to the second side region 412. The fourth side region 414 of each of the first, the second, the third and the fourth sub-panels 41a, 41b, 41c and 41d are perpendicular to the corresponding touch sensing region 410. The fourth side region 414 of the third sub-panel 41c is adhered to the fourth side region 414 of the first sub-panel 41a, the fourth side region 414 of the fourth sub-panel 41d is adhered to the fourth side region 414 of the second sub-panel 41b, and the first side region 411 of the third sub-panel 41c is adhered to the first side region 411 of the fourth sub-panel 41d.

In the third embodiment, the four touch sensing regions 410 of the four sub-panels 41a, 41b, 41c and 41d are joined to form a large sensing region of the touch panel 40. The third side region 413 of the first sub-panel 41a and the third side region 413 of the third sub-panel 41c are joined. The third side region 413 of the second sub-panel 41b and the third side region 413 of the fourth sub-panel 41d are joined. The second side region 412 of the first sub-panel 41a and the second side region 412 of the second sub-panel 41b are joined, and the second side region 412 of the third sub-panel 41c and the second side region 412 of the fourth sub-panel 41d are joined

Moreover, it can be understood, each of the third sub-panel and the fourth sub-panel also a CNT film covering the corresponding touch sensing region 110, and the carbon nanotubes of the four CNT films of the four sub-panels 41a, 41b, 41c and 41d extend along the same direction.

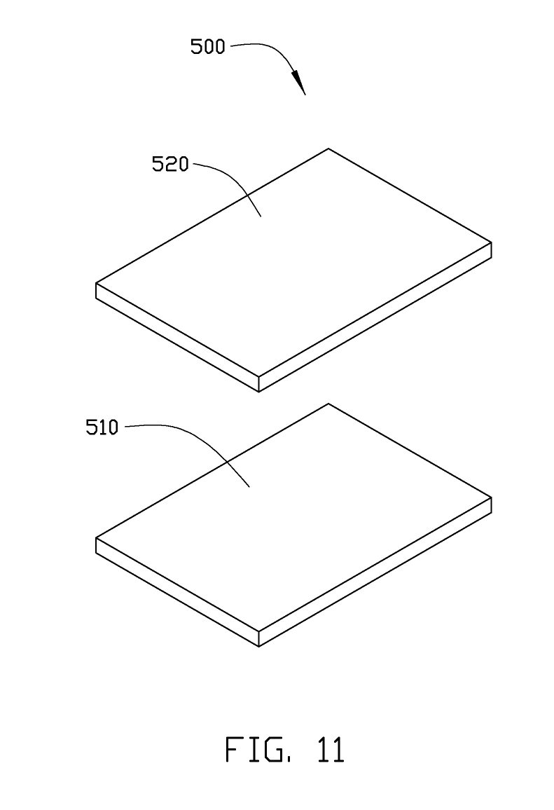

FIG. 11 shows that a touch display apparatus 500 according to an embodiment of the present disclosure. The touch display apparatus 500 includes a display panel 510 and a touch panel 520 positioned above the display panel 510. The touch panel 520 may be adopted the above touch panel 10, 20 and 30. The display panel 520 may be a liquid crystal display (LCD) panel, an organic light Emitting diode (OLED) display panel or a plasma display panel (PDP).

It is to be understood that even though numerous characteristics and advantages of the present embodiments have been set forth in the foregoing description, together with details of the structures and functions of the embodiments, the disclosure is illustrative only; and that changes may be made in detail, especially in the matters of shape, size, and arrangement of parts, within the principles of the embodiments, to the full extent indicated by the broad general meaning of the terms in which the appended claims are expressed.

What is claimed is:

1. A touch panel, comprising:
a first sub-panel and
a second sub-panel;
wherein one of the first sub-panel and the second sub-panel comprises a carbon nanotube (CNT) film, each of the first sub-panel and the second sub-panel comprises a touch sensing region and a first side region connecting a first side of the touch sensing region, the first side region is bent towards the touch sensing region and an intersection angle is formed between the first side region and the touch sensing region, the first side region of the first sub-panel is attached to the first side region of the second sub-panel such that the touch sensing region of the first sub-panel and the touch sensing region of the second sub-panel are joined together.

2. The touch panel of claim 1, wherein an external surface of the first side region of the first sub-panel is adhered to an external surface of the first side region of the second sub-panel by an adhesive layer.

3. The touch panel of claim 1, wherein the first side region is perpendicular to the touch sensing region.

4. The touch panel of claim 1, wherein each of the first sub-panel and the second sub-panel further comprises a second side region connecting a second side of the touch sensing region and a flexible printed circuit (FPC) electrically connecting the second side region.

5. The touch panel of claim 4, wherein each of the first sub-panel and the second sub-panel further comprises a third side region connecting a third side of the touch sensing region and a fourth side region connecting a fourth side of the touch sensing region, the first, second, third and fourth side regions are joined end to end and form a peripheral region surrounding the touch sensing region.

6. The touch panel of claim 5, wherein each of the first sub-panel and the second sub-panel further comprises a CNT film covering the touch sensing region and a plurality of connection wires, the connection wires are positioned on the peripheral region and are electrically coupled between the CNT film and the FPC.

7. The touch panel of claim 6, wherein the CNT film comprising a plurality of carbon nanotubes orderly arranged, the plurality of carbon nanotubes are arranged along a first direction, each connection wire comprises a first electrode electrically connected to the CNT film, a second electrode electrically connected to the FPC and a first connection portion connected between the first electrode and the second electrode.

8. The touch panel of claim 7, wherein the first side region is positioned opposite to the second side region, the third side region is positioned opposite to the fourth side region, the third side region of the first sub-panel and the third side region of the second sub-panel are joined, and the fourth side region of the first sub-panel and the fourth side region of the second sub-panel are joined together.

9. The touch panel of claim 8, wherein the touch sensing region comprises a first side line located at the first side, and the first side line is parallel to the first direction.

10. The touch panel of claim 8, wherein the first electrodes of the plurality of connection wires are positioned on the third side region and the fourth side region, and the second electrodes of the plurality of connection wires are positioned on the second side region.

11. The touch panel of claim 10, wherein the first electrodes positioned on the third side region are arranged along a second direction perpendicular to the first direction, the first electrodes positioned on the fourth side region are arranged along the second direction, and the second electrodes positioned on the second side region are arranged along the first direction.

12. The touch panel of claim 7, wherein the first side region is positioned adjacent to the second side region and opposite to the third region, the third side region is positioned adjacent to the fourth side region, the second side region of the first sub-panel and the second side region of the second sub-panel are joined, and the fourth side region of the first sub-panel and the fourth side region of the second sub-panel are joined together.

13. The touch panel of claim 12, wherein the touch sensing region comprises a first side line located at the first side, and the first side line is parallel to a second direction perpendicular to the first direction.

14. The touch panel of claim 13, wherein the first electrodes of the plurality of connection wires are positioned on the first side region and the third side region, and the second electrodes of the plurality of connection wires are positioned on the second side region.

15. The touch panel of claim 14, wherein the first electrodes positioned on the first side region are arranged along the second direction, the first electrodes positioned on the third side region are arranged along the second direction, and the second electrodes positioned on the second side region are arranged along the first direction.

16. The touch panel of claim 12, further comprising a third sub-panel and a fourth sub-panel, wherein each of the third sub-panel and the fourth sub-panel comprises a touch sensing region, a first side region, a second side region adjacent to the first side region, a third side region opposite to the first side region, a fourth side region opposite to the second side region, and a FPC connected to the second side region, the fourth side region of each of the first, the second, the third and the fourth sub-panels are perpendicular to the corresponding touch sensing region, the fourth side region of the third sub-panel is attached to the fourth side region of the first sub-panel, the fourth side region of the fourth sub-panel is attached to the fourth side region of the second sub-panel, and the first side region of the third sub-panel is attached to the first side region of the fourth sub-panel, such that the four touch sensing regions of the four sub-panels are joined together.

17. The touch panel of claim 16, wherein each of the third sub-panel and the fourth sub-panel comprises a CNT film covering the corresponding touch sensing region, and the carbon nanotubes of the four CNT films of the four sub-panels extend along a same direction.

18. A touch display apparatus, comprising:
a display panel; and
a touch panel positioned above the display panel, the touch panel comprising:
a first sub-panel and
a second sub-panel;
wherein one of the first sub-panel and the second sub-panel comprises a carbon nanotube (CNT) film, each of the first sub-panel and the second sub-panel comprises a touch sensing region and a first side region connecting a first side of the touch sensing region, the first side region is bent towards the touch sensing region and an intersection angle is formed between the first side region and the touch sensing region, the first side region of the first sub-panel is attached to the first side region of the second sub-panel such that the touch sensing region of the first sub-panel and the touch sensing region of the second sub-panel are joined together.

19. The touch display apparatus of claim 18, wherein the side region is perpendicular to the touch sensing region, and an external surface of the first side region is adhered to an external surface of the second side region by an adhesive layer.

20. The touch display apparatus of claim 18, wherein each of the first sub-panel and the second sub-panel further comprises a CNT film covering the touch sensing region, a second side region connecting a second side of the touch sensing region, a third side region connecting a third side of the touch sensing region, a fourth side region connecting a fourth side of the touch sensing region, a flexible printed circuit (FPC) electrically connecting the second side region and a plurality of connection wires electrically connected between the CNT film and the FPC.
